(19) United States
(12) Patent Application Publication
(10) Pub. No.: US 2025/0007082 A1
(43) Pub. Date: Jan. 2, 2025

(54) BATTERY ASSEMBLY HAVING A CELL DEGASSING CHANNEL, MOTOR VEHICLE, AND METHOD FOR DISCHARGING GASES FROM A BATTERY

(71) Applicant: AUDI AG, Ingolstadt (DE)

(72) Inventors: Carsten LORENZ, Reichertshofen (DE); Paul SCHNEIDER, Großmehring (DE); Martin SCHÜSSLER, Kösching (DE)

(73) Assignee: AUDI AG, Ingolstadt (DE)

(21) Appl. No.: 18/697,103

(22) PCT Filed: Sep. 12, 2022
(86) PCT No.: PCT/EP2022/075232

§ 371 Date: Mar. 29, 2024

(30) Foreign Application Priority Data
Sep. 29, 2021 (DE) 102021125191.5

(51) Int. Cl. H01M 50/358; B60L 50/64; H01M 50/383

(52) U.S. Cl. CPC H01M 50/358; B60L 50/64; H01M 50/383; H01M 2220/20

(57) ABSTRACT

A battery assembly with a battery and a cell degassing channel for discharging gases from the battery, which includes at least one battery cell. The cell degassing channel has a chamber which is designed such that a gas emerging from the at least one battery cell can be introduced into it and can be guided through it along at least one gas discharge path to at least one outlet opening of the chamber. The chamber has at least one gas guiding structure arranged in an interior of the chamber and not running in a straight line in a main course direction that corresponds to a first direction, which is designed such that the at least one gas discharge path has multiple changes of direction in its course in the main course direction with respect to a second direction perpendicular to the first direction.

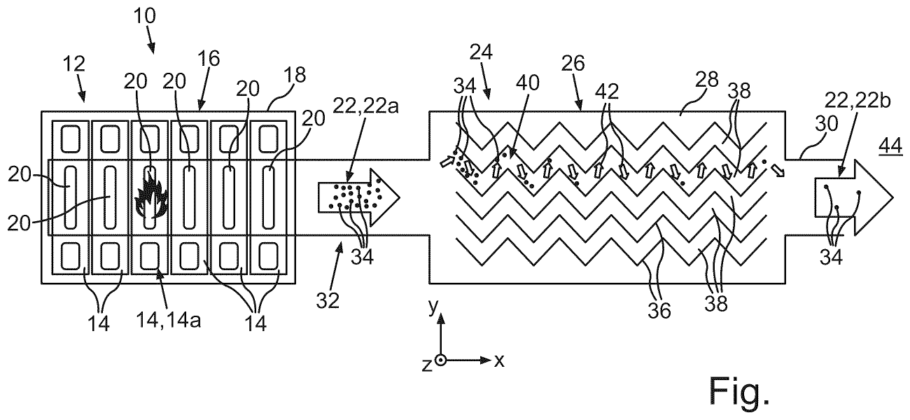

### FIELD

The invention relates to a battery assembly with a battery and a cell degassing channel for discharging gases from the battery, which comprises at least one battery cell, wherein the cell degassing channel has a chamber which is designed such that a gas emerging from the at least one battery cell can be introduced into it and can be guided through it along at least one gas discharge path to at least one outlet opening of the chamber. Furthermore, the invention also relates to a motor vehicle having such a battery assembly and a method for discharging gases from a battery.

### BACKGROUND

Batteries for motor vehicles, in particular high-voltage batteries, are known from the prior art. Such high-voltage batteries typically have a large number of battery cells, which under certain circumstances can also be combined to form cell modules. In the event of a defect in a battery cell, for example in the event of a short circuit, there is a risk that such a battery cell will thermally run away. In the event of such a thermal runaway, the battery cell typically outgasses, wherein particles from the cell are also carried away by the gas flow. In order to enable a defined outgassing of a battery cell, the battery cells typically have releasable degassing openings in the form of, for example, bursting membranes. In order for the particles escaping during outgassing of a cell to not settle in an uncontrolled manner in the battery system, which can lead to blockage of flow cross-portions and short circuiting of other cells within the battery, the gas escaping from the cells should be transported away in a controlled manner, for example via a cell degassing channel. Another problem is that the gases can self-ignite when they exit the battery system, for example via said cell degassing channel. This is due, on the one hand, to the high gas temperature and, on the other hand, to the hot particles contained in the gas. Accordingly, it would be desirable to be able to reduce the outlet temperature of such a harmful gas and of the particles contained therein to such an extent that the outburst of a flame from the battery system or a spontaneous ignition of the gas outside the battery or the motor vehicle can be ruled out.

For this purpose, DE 10 2011 105 981 A1 describes a lithium-ion battery defect prevention system, according to which the battery cell gas is treated in the internal combustion engine exhaust system. In order to feed the battery exhaust gas to the exhaust system, a blower or air pump is required, among other things. The main problems with such active elements are that their functionality cannot be guaranteed in the event of an accident involving a motor vehicle. If these are defective or their functionality is impaired, the battery gas cannot be properly discharged, which can have fatal consequences.

Furthermore, DE 10 2018 125 446 A1 describes a battery housing for accommodating one or more battery modules with a housing portion for partially delimiting the interior of the housing, the housing portion having an integrated exhaust duct for discharging media exiting the battery module in the event of a defect. The exhaust duct has at least one deflection region which is designed to change the transport direction of the media. The deflection slows down any entrained particles. For example, sparks that can ignite the exhaust gas are prevented from leaving the battery housing.

Nevertheless, there are still efforts to make the discharge of harmful gases from a battery even more efficient and safer.

### SUMMARY

It is therefore the object of the present invention to provide a battery assembly and a method which enable gases escaping from a battery cell to be discharged in the safest and most efficient manner possible.

The invention relates to a battery assembly with a battery and a cell degassing channel for discharging gases from the battery, which comprises at least one battery cell, wherein the cell degassing channel has a chamber which is designed such that a gas emerging from the at least one battery cell can be introduced into it and can be passed through it along at least one gas discharge path to at least one outlet opening of the chamber. The chamber has at least one gas guiding structure arranged in an interior of the chamber and not running in a straight line in a main course direction that corresponds to a first direction, which is designed such that the at least one gas discharge path has multiple changes of direction in its course in the main course direction with respect to a second direction perpendicular to the first direction.

Such a gas guiding structure ensures that the gas discharge path, along which gas flowing through the chamber can be guided to the outlet opening of the chamber, does not run in a straight line, but is deflected multiple times as described, in particular with respect to a direction perpendicular to the main course direction of extension. The gas discharge path can, for example, run in a serpentine, zigzag, wavy or meandering manner. In other words, the gas propagates along this gas discharge path in the main course direction, but is directed along a curved or zigzag-shaped trajectory. This allows multiple major advantages to be achieved at the same time: on the one hand, this creates great friction between the guided gas and the gas guiding structure, which leads to the gas guiding structure being heated by the guided gas. The temperature of the gas also decreases accordingly. The friction additionally decelerates and slows down the gas flowing through. This in turn also leads to additional cooling of the gas. Another very positive side effect is that particles are deposited in the gas due to the constant contact with the gas control structure. The result of this is that the gas emerging from the outlet opening is ultimately significantly cooled and has significantly fewer particles, so that overall the risk of ignition of the emerging gas is enormously reduced or can even be eliminated. However, another particularly great advantage is precisely that such gas guidance is not provided by a single large channel that is bent or twisted multiple times, but instead by at least one gas control structure that is arranged within a chamber. This divides the interior of the chamber, at least in some regions, into at least two sub-spaces. If multiple gas guiding structures of this type are provided, as will be explained in more detail later, the interior can even be divided into numerous individual flow channels that are mostly spatially separated from one another. A single such flow channel or gas discharge path can thus be made significantly narrower, which in turn promotes particle separation, the reduction of the flow velocity and the cooling of the gas. At the same time, the interior can still provide a very large total volume and the gas introduced into the chamber can, for example, be distributed into the individual sub-spaces. A large total volume is enormously advantageous because, on the one hand, this has the effect that the gas expands when it enters this large total volume and thereby cools down. On the other hand, clogging of bottlenecks through increased particle separation can also be efficiently prevented. This allows the safety and efficiency of gas discharge to be further increased. By integrating at least one gas guiding structure into the interior of the chamber, in particular through the integration of multiple such gas guiding structures into the interior of the chamber, the overall ratio between the wall area that can come into contact with the gas flow and the interior volume can be significantly increased, with not only the chamber walls contributing to the wall surface area, but also the gas guiding structures. This maximizes the contact surface that the gas comes into contact with as it flows through the chamber, which can achieve maximum particle separation, speed reduction and deceleration as well as a reduction in temperature. In addition, the provision of the gas guiding structures provides more mass overall that can absorb thermal energy. This can also increase the efficiency of gas cooling.

The chamber can be designed as a kind of spark trap, so to speak. With conventional spark traps, which are used for welding systems, for example, the effect is used that sparks can be intercepted in such a trap, which sparks therefore cannot escape at the other end. However, when using such a spark trap in a battery assembly, this function is less useful because the gas flowing out of a cell does not contain sparks anyway. Rather, the invention is based on the additional knowledge that such a spark trap can also achieve advantageous effects in connection with outgassing battery cells, especially through such a spark trap not only particle separation but, above all, also deceleration and cooling of a gas emerging from a battery cell can be achieved.

In general, within the scope of the invention, when a gas is mentioned, it should always be understood as meaning a gas emerging or leaked from the at least one battery cell, for example in the event of a defect in the battery cell or a thermal runaway of the battery cell. The battery can be, for example, a high-voltage battery. The battery can have not only a single battery cell, but also, for example, multiple battery cells, in particular numerous battery cells. These can basically be designed in any way, for example as round cells, prismatic cells or pouch cells. The at least one battery cell is moreover formed, for example, as a lithium-ion cell. If the battery comprises multiple battery cell, they can optionally be combined into battery modules. In other words, the battery can comprise multiple battery modules, each of which comprises multiple battery cells. The described cell degassing channel with the chamber can be provided per battery cell or per battery module or also for the entire battery. In other words, the battery can only have one cell degassing channel with such a chamber into which the gases of all cells of the battery that may be degassing are introduced. Alternatively, the battery can also have multiple cell degassing channels with respective such chambers, for example per battery module or even per battery cell. It is also conceivable that a common cell degassing channel is used for multiple battery cells and/or battery modules, but that this channel has multiple such chambers, for example one per module or per cell. Furthermore, it is conceivable that the battery cell is arranged in relation to the chamber in such a way that the gas emerging from a releasable degassing opening assigned to the battery cell can be introduced directly into the chamber or alternatively indirectly via an additional degassing channel portion. There are also numerous possibilities with regard to the arrangement of the chamber in relation to the battery cell or the battery, which in principle are not limited.

The chamber can also have chamber walls that delimit the interior of the chamber. On the one hand, at least one at least releasable inlet opening can be provided in these chamber walls, through which opening the gas emerging from the at least one battery cell can enter. An at least releasable inlet opening is to be understood in particular as an opening which can either be permanently open, for example in the manner of a hole or aperture, or which is closed during normal operation and is only released under certain conditions, for example in the event of overpressure, similarly to a pressure relief valve or an opening closed by a burst membrane. The chamber can only have one such at least releasable inlet opening or multiple of the same. In the case of multiple such releasable inlet openings, these can be assigned to respective cells and/or battery modules, for example. The outlet opening of the chamber can also be closed during normal operation, for example, or designed with a closure, for example also with a bursting membrane. Or the outlet opening can be designed as a permanent opening of the chamber. Here too, it is conceivable that the chamber not only has one outlet opening, but also, for example, multiple of such openings. Since the gas guiding structure divides the chamber into subregions, it is also conceivable, for example, that such an outlet opening is assigned to a respective gas guiding path. Nevertheless, the gas flowing through the chamber, in particular gas flowing along different gas discharge paths, can be directed to a common outlet opening of the chamber.

The fact that the gas discharge path has multiple changes of direction in its course in the main course direction with respect to a second direction perpendicular to the first direction preferably means that a gas flowing along this gas discharge path, at least on average, always has a speed component pointing in the main course direction, which becomes smaller in particular as it moves, as well as a speed component perpendicular to the main course direction, which repeatedly changes its sign, i.e. points in the second direction, and then after deflection is directed against the second direction, and then after another deflection is directed again in the second direction, and so on.

Preferably, the at least one gas guiding structure, in particular the plurality of gas guiding structures, is designed such that the at least one gas discharge path does not branch into a dead end. In other words, no dead ends should be formed by the at least one or more gas guiding structures. This is based on the knowledge that dead ends in the gas discharge path lead to a gas backflow, which on the one hand promotes the clogging of bottlenecks by depositing particles and thus a complete blockage of parts of a gas discharge path, and on the other hand leads to incoming gas simply flowing over such a dead end due to the backflowing gas and thus it remains ineffective in the further course.

It is particularly advantageous if the at least one gas guiding structure runs in a zigzag or wave shape in the main course direction. A zigzag-shaped structure in particular has proven to be particularly efficient and advantageous. In contrast to a wave-shaped course, such a zigzag structure has a much more abrupt change in direction at the reversal points. This is transferred analogously to the gas discharge path. This can also be shaped in its course by the gas guiding structure in such a way that it runs in a zigzag shape or wave shape in the main course direction. This allows the above-mentioned effects to be achieved in a particularly simple and efficient manner. The gas guiding structure can be designed in the form of a zigzag-shaped or wave-shaped partition wall. This can also extend continuously from one chamber wall to the opposite chamber wall, in particular with respect to a third direction, or it can also be spaced from the chamber walls. Accordingly, a holder can also be provided to hold the gas guiding structure if it is not directly connected to a chamber wall. Such a holder can then be arranged accordingly on one or more chamber walls. Furthermore, the at least one gas guiding structure can be designed to run straight in a third direction that is perpendicular to the first and second directions. In other words, the gas guiding structure can be designed to be translation-invariant in the third direction with regard to its geometric shape. For example, the gas guiding structure can be designed so that it has the same geometric configuration in every cross section perpendicular to the third direction. The gas guiding structure can therefore be designed, for example, in the manner of a corrugated sheet or sheet metal structured in a zigzag shape. The rectilinear design in the third direction enables a particularly simple formation of the gas guiding structure and, in addition, gas deceleration should take place primarily in the main course direction. Accordingly, it is advantageous if the at least one outlet opening of the chamber and at least one releasable inlet opening of the chamber are arranged in different halves of the chamber with respect to this first direction. This results in the gas propagating along the at least one gas discharge path propagating in the main course direction and thus being efficiently cooled and decelerated, in particular by the gas guiding structure varying in the main course direction. The velocity component of the gas in the third direction, in which the gas guiding structure is designed to be rectilinear, is therefore relatively low and, at least on average, approximately zero.

In a particularly advantageous embodiment of the invention, the chamber in the interior has a plurality of gas guiding structures comprising the at least one gas guiding structure, wherein the multiple gas guiding structures do not run in a straight line in the main course direction, so that a gas discharge path is provided between two gas guiding structures of the plurality of gas guiding structures arranged adjacently in the second direction, which has multiple changes of direction in its course in the main course direction with respect to a second direction perpendicular to the first. The chamber preferably has such a large number of gas guiding structures that a plurality of gas discharge paths that are separated at least in some regions by the gas guiding structures are also provided. These therefore run between two respective adjacently arranged gas control structures. This allows the entire interior of the chamber to be divided into multiple gas discharge paths. This allows a narrower design of the respective gas discharge paths, which in turn enables efficient cooling, speed reduction and particle separation, while at the same time maintaining the largest possible overall volume.

The respective multiple gas guiding structures can be designed as already described for at least one gas guiding structure, that is, for example, also zigzag or wave-shaped in the main course direction.

It is also very advantageous if the multiple gas guiding structures are designed in the same way and are arranged parallel to one another. This accordingly also allows the formation of multiple gas discharge paths, which also run parallel to one another in the main course direction, in particular in a zigzag shape or wave shape. This allows the chamber to be extremely compact.

In a particularly advantageous embodiment of the invention, the at least one gas guiding structure is made of a metallic material. For example, the at least one gas guiding structure can be made of aluminum and/or steel and/or copper. It is also conceivable to manufacture the various gas guiding structures from different materials. Metallic materials generally have the great advantage that they can absorb heat very quickly. Furthermore, they are very temperature-stable, especially compared to most plastics. Nevertheless, other materials are also conceivable that have a sufficiently high temperature stability, for example a melting point above several 100 degrees Celsius, under normal conditions, preferably above 600 degrees Celsius, preferably above 800 degrees Celsius, or higher. At the same time, a material with high thermal conductivity is advantageous in order to be able to absorb heat quickly.

In a further advantageous embodiment of the invention, the interior of the chamber has a width in the third direction and a length in the first direction, wherein the at least one gas guiding structure extends in the third direction at least over a large part of the width and/or in the first direction at least over a large part of the length of the interior. Preferably, the at least one gas guiding structure extends in the third direction preferably over at least almost the entire width of the interior, for example over at least 90 percent or 95 percent, and in the first direction preferably over almost the entire length of the interior, for example also over at least 90 percent or 95 percent. It is also conceivable, for example, for the gas guiding structure to extend over the entire width in the third direction and, for example, to be in direct contact with the chamber walls. It is also conceivable that the gas guiding structure extends in the first direction over the entire length of the chamber or its interior and, for example, is also connected to the opposite chamber walls with respect to the first direction. In this case, the gas guiding structure connects, for example, directly to an inlet opening and/or outlet opening of the chamber. In this case, it is advantageous to provide multiple such inlet and outlet openings, each of which opens into a region between two adjacent gas guiding structures. But even if the gas guiding structure does not directly contact the chamber walls, the above-described design of the gas guiding structure, which extends at least almost over the entire length and width of the interior, allows the interior to be efficiently divided into individual gas discharge paths, especially if several of these parallel running gas guiding structures are provided. In addition, the interior of the chamber can have a height in the second direction, wherein the overall arrangement of the plurality of gas guiding structures extends in the second direction over the majority of the height, in particular over almost the entire height. The distance of the overall arrangement of the gas guiding structures in the second direction from the chamber walls delimiting the interior in the second direction can be at most as large or even smaller than a maximum distance in the second direction between two gas guiding structures arranged adjacently in the second direction.

In a further advantageous embodiment of the invention, the plurality of gas discharge paths provided between the gas deflection structures are fluidically coupled to one another in a gas inlet region of the chamber and/or in a region of the outlet opening. This makes it possible, for example, to use a common gas inlet region and/or a single outlet opening to remove the gases from the chamber. The gas introduced into the chamber via a common gas inlet region of the chamber is then divided into the individual gas discharge paths only after it has been introduced into the chamber. Analogously, the gases guided via the separate gas discharge paths are brought together again in the outlet region, that is to say in the region of the outlet opening, and together leave this outlet opening. This simplifies the structure of the chamber without reducing its efficiency. Nevertheless, it is also conceivable that the multiple gas discharge paths provided between the gas guiding structures are completely fluidically separated from one another within the interior of the chamber. Accordingly, an inlet opening and an outlet opening of the chamber can then be assigned to each gas discharge path.

Furthermore, the invention also relates to a motor vehicle having a battery assembly according to the invention or one of its embodiments. The advantages mentioned for the battery assembly according to the invention and its configurations thus apply similarly to the motor vehicle according to the invention.

The motor vehicle according to the invention is preferably designed as an automobile, in particular as a passenger car or truck, or as a passenger bus or motorcycle.

Furthermore, the invention also relates to a method for discharging gases from a battery with at least one battery cell by means of a cell degassing channel, which has a chamber in which a gas emerging from the at least one battery cell is introduced and through which the gas is guided along at least one gas discharge path at least to one outlet opening of the chamber. The chamber has at least one gas guiding structure arranged in an interior of the chamber and not running in a straight line in a main course direction that corresponds to a first direction, which deflects a gas guided along the at least one gas discharge path to the outlet opening multiple times in its course in the main course direction with respect to a second direction perpendicular to the first direction. The gas is the gas that has escaped from the battery cell.

The advantages mentioned for the battery assembly according to the invention and its embodiments thus apply equally to the method according to the invention. The cell degassing channel used in the course of the method according to the invention can be designed and/or further developed as described for the battery assembly according to the invention and its embodiments. The same also applies to the chamber, its interior and the gas guiding structures included in the chamber.

The invention also includes developments of the method according to the invention, which have features as have already been described in conjunction with the developments of the battery assembly according to the invention. For this reason, the corresponding developments of the method according to the invention are not described again here.

The invention also comprises the combinations of the features of the described embodiments. The invention therefore also comprises implementations that respectively have a combination of the features of several of the described embodiments, provided that the embodiments have not been described as mutually exclusive.

Exemplary embodiments of the invention are described hereinafter. The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

### BRIEF DESCRIPTION OF THE FIGURES

In particular, the single FIGURE shows a schematic representation of a battery module 10 according to an exemplary embodiment of the invention.

### DETAILED DESCRIPTION

The battery assembly 10 in turn has a battery 12, which in this example comprises multiple battery cells 14. These battery cells 14 are combined to form a battery module 16 as an example. The battery 12 can also comprise a plurality of such battery modules 16. Furthermore, the battery cells 14 in this example are designed as prismatic cells and arranged in a battery housing 18. Each battery cell 14 has a releasable cell degassing opening 20. This can be provided through an opening in the cell housing of the cells 14, which is closed, for example, by a bursting membrane during normal operation. In the event of a defect in a battery cell 14, as in this example of a battery cell 14a, this opening 20 can open due to the overpressure created in the cell 14, whereby the cell 14 can outgas in a controlled manner. In order to remove the gas 22 in a controlled manner from the battery 12 and in particular from the motor vehicle in which the battery assembly 10 is arranged, the battery assembly 10 also has a cell degassing channel 24. This comprises a chamber 26 with an interior 28, into which the gas 22 emerging from the cell 14a can be introduced and through which this introduced gas 22 can be passed through to an outlet opening 30 of the chamber 26. In this example, the cell degassing channel 24 has a further channel portion 32, into which the gas 22 emerging from the cells 14 can be introduced and via which the gas 22 introduced into this channel portion 32 can be introduced into the chamber 26 fluidly coupled to this channel portion 32. However, it would also be conceivable to dispense with this additional channel portion 32 and to couple the chamber 26 to the battery 12 in such a way that the gas 22 emerging from the cells 14 can also be introduced directly into the chamber 26 or into the interior 28. The chamber 26 can therefore be provided as a separate housing, for example per module 16 or per battery 12, and the chamber 26 can also be designed as an extension of the gas channel 32.

The gas 22 introduced into the chamber 26 in the present example is very hot and referred to herein as hot gas 22a and also has numerous particles 34. For reasons of clarity, only some of these particles 34 are provided with a reference numeral. The cooler gas emerging from the outlet opening 30 is designated 22b. In the present case, the passing through the chamber 26 results in a significant cooling of the gas 22, as well as a significant reduction in the number of particles 34 contained in the gas 22. This can now advantageously be achieved by the chamber 26 having multiple gas guiding structures 36 arranged in the interior 28 of the chamber 26. For reasons of clarity, only some of these are provided with a reference numeral. These gas guiding structures 36 are arranged similarly to partition walls in the interior 28. Furthermore, a respective gas guiding structure 36 runs in a main course direction, which in the present case corresponds to the x-direction shown. In this main course direction x, the respective gas guiding structures 36 do not run in a straight line, but rather in a zigzag shape in the present example. Alternatively, these could also be wavy or serpentine. A respective gas discharge path 38 is thus formed between two gas guiding structures 36 arranged directly next to one another in the y direction, which has multiple changes of direction in its course in the main course direction x due to the geometric design of the gas deflection structures 36 with respect to a second direction perpendicular to the first, wherein this second direction in this case corresponds to the y-direction shown. As an example, the FIGURE shows a gas flow 40 running along a gas discharge path 36, wherein this change in direction is illustrated by the arrows 42 pointing alternately in the x direction and in the opposite y direction. These arrows 42 correspond in particular to the current flow direction of the gas flow 40 at the corresponding positions within the gas discharge path 38.

By multiple deflection of the gas flow 40, which flows along such a gas discharge path 38, a deceleration of this gas flow 40 and an associated cooling of the gas flow can be achieved, as well as additional cooling in that this gas flow 40 transfers heat to these gas guiding structures 36, which heat up as a result. These are therefore preferably made of a material that is as temperature-resistant as possible and is preferably also designed to absorb heat as quickly as possible. It is particularly advantageous to provide them made from a metal or an alloy. Accordingly, the gas guiding structures 36 can be provided, for example, as zigzag-shaped sheets, which in particular have the same geometry and, for example, are arranged parallel to one another as shown in the FIGURE. As a result, multiple gas discharge paths 38 running parallel to one another can be provided. The fact that the gas flow 40 collides multiple times with the walls of these gas guiding structures 36 due to the multiple deflection results in increased particle deposition, in particular on the walls of these gas guiding structures 36. Because a plurality of such gas guiding structures 36 are arranged in a common chamber 26, the individual gas discharge paths 38 can be designed to be relatively narrow, which is beneficial for particle separation, deceleration and cooling of the gas flow 40 without reducing the total volume that can flow through. In particular, this can continue to be kept very large, so that, for example, additional gas cooling can be achieved through expansion upon entry into the chamber 26. Ultimately, a cooled harmful gas 22b with few or even no particles 34 emerges through the outlet opening 30. This emerging mixture 22b can no longer self-ignite due to its low temperature and the few particles it contains. The gas 22b escaping into the environment 44 is thus significantly defused in terms of its potential danger. The outlet opening 30 can be positioned in relation to the motor vehicle in which the battery assembly 10 is used so that the emerging gas 22b can be discharged into an environment 44 of the motor vehicle. Alternatively, another part of the cell degassing channel 24 can be connected to this outlet opening 30, which conducts the cooled gas 22b to the final outlet opening, which opens into an environment 44 of the motor vehicle.

Overall, the examples show how a spark trap for battery systems can be provided. By appropriately designing a gas channel as a chamber or by introducing the harmful gas into an extra volume as a chamber, the temperature of the gas is reduced so that the gas does not spontaneously ignite when it leaves the system. The exit temperature of the harmful gas and of the particles contained therein can be reduced by the gas guiding structures encompassed by the chamber to such an extent that a flame escaping from the battery system or self-ignition of the gas outside the battery can be ruled out. To provide the gas guiding structures, multiple specially curved metal sheets are preferably placed next to each other in the interior of the chamber described and the harmful gas is passed between them. Due to the special design, the gas flow is repeatedly redirected and the particles are thrown onto the walls. A direct flowing through without deflection is excluded by the geometry of these sheets, which are referred to here as gas guiding structures. The heat of the gas and of the particles is transferred to the sheets. By reducing the flow speed and deflecting the gas flow, particles are also separated.

1-10. (canceled)

11. A battery assembly with a battery and a cell degassing channel for discharging gases from the battery, which comprises at least one battery cell, wherein the cell degassing channel has a chamber which is designed such that a gas emerging from the at least one battery cell can be introduced into it and can be guided through it along at least one gas discharge path to at least one outlet opening of the chamber,
wherein the chamber has at least one gas guiding structure arranged in an interior of the chamber and not running in a straight line in a main course direction that corresponds to a first direction, which is designed such that the at least one gas discharge path has multiple changes of direction in its course in the main course direction with respect to a second direction perpendicular to the first direction.

12. The battery assembly according to claim 11, wherein the at least one gas guiding structure runs in a zigzag shape or wave shape in the main course direction.

13. The battery assembly according to claim 11, wherein the chamber in the interior has a plurality of gas guiding structures comprising the at least one gas guiding structure, wherein the multiple gas guiding structures do not run in a straight line in the main course direction, so that a gas discharge path is provided between two gas guiding structures of the plurality of gas guiding structures arranged adjacently in the second direction, which has multiple changes of direction in its course in the main course direction with respect to a second direction perpendicular to the first.

14. The battery assembly according to claim 11, wherein the multiple gas guiding structures are designed in the same way and are arranged parallel to one another.

15. The battery assembly according to claim 11, wherein the at least one gas guiding structure is designed to run straight in a third direction, which is perpendicular to the first and second directions.

16. The battery assembly according to claim 11, wherein at least one gas guiding structure is formed from a metallic material.

17. The battery assembly according to claim 11, wherein the interior of the chamber has a width in the third direction and a length in the first direction, and the at least one gas guiding structure extends in the third direction at least over a large part of the width of the interior and/or extends in the first direction at least over a large part of the length of the interior.

18. The battery assembly according to claim 11, wherein the multiple gas discharge paths provided between the gas guiding structures are fluidly coupled to one another in a gas inlet region of the chamber and/or in the region of the outlet opening.

19. A motor vehicle having a battery assembly according to claim 11.

20. A method for discharging gases from a battery with at least one battery cell by a cell degassing channel which has a chamber into which a gas emerging from the at least one battery cell is introduced and through which the gas is guided along at least one gas discharge path to at least one outlet opening of the chamber,
wherein the chamber has at least one gas guiding structure arranged in an interior of the chamber and not running in a straight line in a main course direction that corresponds to a first direction, which deflects a gas guided along the at least one gas discharge path to the outlet opening multiple times in its course in the main course direction with respect to a second direction perpendicular to the first direction.

21. The battery assembly according to claim 12, wherein the chamber in the interior has a plurality of gas guiding structures comprising the at least one gas guiding structure, wherein the multiple gas guiding structures do not run in a straight line in the main course direction, so that a gas discharge path is provided between two gas guiding structures of the plurality of gas guiding structures arranged adjacently in the second direction, which has multiple changes of direction in its course in the main course direction with respect to a second direction perpendicular to the first.

22. The battery assembly according to claim 12, wherein the multiple gas guiding structures are designed in the same way and are arranged parallel to one another.

23. The battery assembly according to claim 13, wherein the multiple gas guiding structures are designed in the same way and are arranged parallel to one another.

24. The battery assembly according to claim 12, wherein the at least one gas guiding structure is designed to run straight in a third direction, which is perpendicular to the first and second directions.

25. The battery assembly according to claim 13, wherein the at least one gas guiding structure is designed to run straight in a third direction, which is perpendicular to the first and second directions.

26. The battery assembly according to claim 14, wherein the at least one gas guiding structure is designed to run straight in a third direction, which is perpendicular to the first and second directions.

27. The battery assembly according to claim 12, wherein at least one gas guiding structure is formed from a metallic material.

28. The battery assembly according to claim 13, wherein at least one gas guiding structure is formed from a metallic material.

29. The battery assembly according to claim 14, wherein at least one gas guiding structure is formed from a metallic material.

30. The battery assembly according to claim 15, wherein at least one gas guiding structure is formed from a metallic material.
